(19) United States
(12) Patent Application Publication
(10) Pub. No.: US 2025/0391876 A1
(43) Pub. Date: Dec. 25, 2025

(54) NEGATIVE ELECTRODE FOR ALL-SOLID-STATE BATTERY, AND ALL-SOLID-STATE BATTERY INCLUDING SAME

(71) Applicant: SAMSUNG SDI CO., LTD., Yongin-si, Gyeonggi-do (KR)

(72) Inventors: Dongho KOO, Yongin-si, Gyeonggi-do (KR); Eungyeong LEE, Yongin-si, Gyeonggi-do (KR); Sangkyu LEE, Yongin-si, Gyeonggi-do (KR); Jangwook LEE, Yongin-si, Gyeonggi-do (KR); Bohyung LEE, Yongin-si, Gyeonggi-do (KR)

(73) Assignee: SAMSUNG SDI CO., LTD., Yongin-si, Gyeonggi-do (KR)

(21) Appl. No.: 18/879,706

(22) PCT Filed: Jan. 9, 2024
(86) PCT No.: PCT/KR2024/000388

§ 371 Date: Dec. 27, 2024

(30) Foreign Application Priority Data
Apr. 7, 2023 (KR) 10-2023-0046249

(51) Int. Cl. H01M 4/62; H01M 4/02; H01M 4/36; H01M 10/052; H01M 10/0562

(52) U.S. Cl. CPC H01M 4/625; H01M 4/366; H01M 4/626; H01M 10/052; H01M 10/0562; H01M 2004/021; H01M 2004/027; H01M 2300/0068

(57) ABSTRACT

The present invention relates to a negative electrode for an all-solid-state battery, and an all-solid-state battery including same, the negative electrode for an all-solid-state battery comprising: a current collector, a primer layer, which is positioned on the current collector, includes a linear carbon-based material and has thickness of 1 μm or less, and a negative electrode coating layer, which is positioned on the primer layer and includes amorphous carbon and metal.

### CROSS-REFERENCE TO RELATED APPLICATION

This application is a National Stage Application of International Application No. PCT/KR2024/000388 filed on Jan. 9, 2024, which claims priority to and the benefit of Korean Patent Application No. 10-2023-0046249 filed at the Korean Intellectual Property Office on Apr. 7, 2023, the entire contents both of which are incorporated herein by reference. To the extent appropriate, a claim of priority is made to each of the above disclosed applications.

### TECHNICAL FIELD

A negative electrode for an all-solid-state battery and an all-solid-state battery including the same are disclosed.

### BACKGROUND ART

Recently, the rapid supplement of electronic devices such as mobile phones, laptop computers, and electric vehicles, using batteries require surprising increases in demands for rechargeable batteries with relatively high capacity and lighter weight. Particularly, a rechargeable lithium battery has recently drawn attention as a driving power source for portable devices, as it has lighter weight and high energy density. Accordingly, research and development to improve the performance of rechargeable lithium batteries is being actively conducted.

An all-solid-state battery among rechargeable lithium batteries refers to a battery in which all materials are solid, and in particular, a battery using a solid electrolyte.

### DETAILED DESCRIPTION OF THE INVENTION

### Technical Problem

An embodiment provides a negative electrode for an all-solid-state battery exhibiting excellent electrochemical properties.

Another embodiment provides an all-solid-state battery including the negative electrode.)

### Technical Solution

An embodiment provides a negative electrode for an all-solid-state battery including a current collector; a primer layer located on the current collector, including a linear carbon-based material, and having a thickness of less than or equal to 1 μm; and a negative electrode coating layer including a carbon material and a metal on the primer layer.

The linear carbon-based material may include a carbon nanotube, a carbon nanofiber, or a combination thereof. The carbon nanotube may be a single-walled carbon nanotube, a double-walled carbon nanotube, a multi-walled carbon nanotube, or a combination thereof.

A thickness of the primer layer may be 0.01 μm to 1 μm.

A thickness ratio of the primer layer and the negative electrode coating layer may be 1:2 to 1:10.

An aspect ratio of the linear carbon-based material may be 500 to 10,000.

The primer layer may have a sheet resistance of 0.1 mΩ/sq to 10 mΩ/sq.

An average length of the linear carbon-based material may be 0.01 μm to 10 μm.

The metal may include Ag, Au, Sn, Zn, Al, Mg, Ge, Cu, In, Ni, Bi, Pt, Pd, or a combination thereof.

The carbon material may be amorphous carbon, crystalline carbon, or a combination thereof. The amorphous carbon may be carbon black, acetylene black, denka black, ketjen black, furnace black, activated carbon, or a combination thereof and the crystalline carbon may be natural graphite, artificial graphite, mesophase carbon microbead, or a combination thereof.

Another embodiment provides an all-solid-state battery including the negative electrode; the positive electrode; and a solid electrolyte layer between the negative electrode and the positive electrode.

The solid electrolyte may be a sulfide-based solid electrolyte.

The all-solid-state battery may further include a lithium-containing layer between the current collector and the negative electrode coating layer during initial charging.

### Advantageous Effects

A negative electrode for an all-solid-state battery according to an embodiment has excellent adhesive strength between a current collector and a negative electrode coating layer, thereby exhibiting improved processability and excellent electrochemical characteristics.

### BRIEF DESCRIPTION OF THE DRAWINGS

FIG. 1 is a schematic view of the negative electrode of an all-solid-state battery according to an embodiment.

FIG. 2 is a schematic view of an all-solid-state battery according to an embodiment.

FIG. 3 is a schematic cross-sectional view showing the state of an all-solid-state battery after charging according to an embodiment.

### BEST MODE FOR PERFORMING INVENTION

Hereinafter, embodiments of the present invention will be described in However, these embodiments are merely examples, the present detail.

invention is not limited thereto, and the present invention is defined by the scope of claims.

The terminology used herein is used to describe embodiments only, and is not intended to limit the present disclosure. Expressions in the singular include a plurality of expressions unless the context clearly dictates otherwise.

As used herein, “combination thereof” means a mixture, a laminate, a composite, a copolymer, an alloy, a blend, a reaction product, and the like of the constituents.

Here, the term “comprise,” “include” or “have” are intended to designate that the performed characteristics, numbers, step, constituted elements, or a combination thereof is present, but it should be understood that the possibility of presence or addition of one or more other characteristics, numbers, steps, constituted element, or a combination do not be precluded in advance.

The drawing shows that the thickness is enlarged in order to clearly show the various layers and regions, and the same reference numerals are given to similar parts throughout the specification. It will be understood that when an element such as a layer, film, region, or substrate is referred to as being “on” another element, it may be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

Herein, “or” is not to be construed as an exclusive meaning, for example, “A or B” is construed to include A, B, A+B, and the like.

Unless otherwise defined in this specification, particle diameter or size may be an average particle diameter. This average particle diameter refers to the average particle diameter (D50), which means the diameter of particles with a cumulative volume of 50 volume % in the particle size distribution. The average particle diameter (D50) may be measured by methods well known to those skilled in the art, for example, by measuring with a particle size analyzer, a transmission electron microscope or scanning electron microscope, or a scanning electron microscope. Alternatively, a dynamic light-scattering measurement device is used to perform a data analysis, and the number of particles is counted for each particle size range, and from this, the average particle diameter (D50) value may be easily obtained through a calculation.

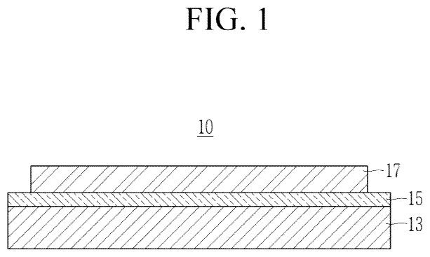

A negative electrode for an all-solid-state battery according to an embodiment includes a current collector; a primer layer on the current collector; and a negative electrode coating layer on the primer layer. FIG. 1 illustrates a negative electrode according to an embodiment, wherein the negative electrode 10 includes a current collector 13 and a negative electrode coating layer 17, and a primer layer 15 is disposed between the current collector 13 and the negative electrode coating layer 17.

In an embodiment, the primer layer may be located on one or both surfaces of the current collector, and if the primer layer is located on both surfaces of the current collector, the negative electrode coating layer may also be located on both surfaces.

The primer layer includes a linear carbon-based material, and the linear carbon-based material may be a carbon nanotube, a carbon nanofiber, or a combination thereof. The carbon nanotube may be a single-walled carbon nanotube, a double-walled carbon nanotube, a multi-walled carbon nanotube, or a combination thereof.

An aspect ratio of the linear carbon-based material may be 500 to 10000, 500 to 5000, or 500 to 2500. The aspect ratio is a ratio of the lengths of the major and minor axes of a linear carbon-based material, where the major axis refers to the longer axis in the cross section of the linear carbon-based material, and the minor axis refers to the shorter axis. Accordingly, the size corresponding to the thickness of the linear carbon-based material is not included in the definition of the aspect ratio. If the aspect ratio of the linear carbon-based material is within the above range, the advantages of high electrical conductivity and mechanical strength may be obtained.

An average length of the above linear carbon-based material may be 1 μm to 10 μm, 2 μm to 8 μm, or 3 μm to 7 μm. The average length of a linear carbon-based material does not necessarily mean a completely straight length, but may be a length corresponding to the major axis even if the linear carbon-based material present in the negative electrode coating layer is bent.

In an embodiment, the thickness of the primer layer may be less than or equal to 1 μm, for example, 0.01 μm to 1 μm, 0.1 μm to 1 μm, or 0.5 μm to 1 μm. If the thickness of the primer layer is thicker than 1 μm, the charge/discharge capacity and coulombic efficiency are reduced, making it unsuitable.

In an embodiment, a thickness ratio of the primer layer and the negative electrode coating layer may be 1:2 to 1:10, 1:5 to 1:9, or 1:5 to 1:7. If the thickness ratio of the primer layer and the negative electrode coating layer is within the above range, it may have the advantage of exhibiting high capacity and low resistance during discharge.

The primer layer may have a sheet resistance of 0.1 mΩ/sq to 10 mΩ/sq. For example, the sheet resistance of the primer layer may be 0.1 mΩ/sq to 5 mΩ/sq, 0.1 mΩ/sq to 3 mΩ/sq, or 0.1 mΩ/sq to 1 mΩ/sq. If the sheet resistance of the primer is within the above range, the cycle-life and capacity characteristics of the rechargeable battery may be improved. In an embodiment, the sheet resistance may be measured using the Four-Point Probe (FPP) method.

In this way, the negative electrode according to an embodiment includes a primer layer including a linear carbon-based material between the current collector and the negative electrode coating layer, so that the primer layer improves the adhesive strength between the current collector and the negative electrode coating layer, thereby effectively preventing peeling of the current collector and the negative electrode coating layer during electrode manufacturing. This linear carbon-based material has a large surface area, which may increase a contact area with the active material in the binder and negative electrode coating layer, thereby improving adhesive strength.

In addition, the primer layer may also serve as a protective layer for the current collector, effectively suppressing side reactions that may occur if the current collector comes into contact with the electrolyte during charging and discharging.

In addition, if charging an all-solid-state battery including this negative electrode, a lithium-containing layer formed on a current collector may be uniformly formed, effectively suppressing generation of dendrites.

The primer layer may further include a binder. Examples of the binder may include a styrene butadiene rubber (SBR), polytetrafluoroethylene, polyvinylidene fluoride, polyethylene, a vinylidene fluoride/hexafluoropropylene copolymer (i.e., polyvinylidene fluoride-hexapropylene), polyacrylonitrile, polymethylmethacrylate, carboxymethyl cellulose, hydroxypropylcellulose, diacetylcellulose, or a combination thereof. The carboxymethyl cellulose may be an alkali metal salt thereof, and the alkali metal may be Na or Li. The binders are not limited to these and any binder used in the relevant technical field may be used.

If the primer layer further includes a binder, an amount of the binder may be 0.1 wt % to 20 wt %, 0.1 wt % to 10 wt %, or 1 wt % to 10 wt % based on 100 wt % of the total primer layer. At this time, the amount of the linear carbon-based material may be 80 wt % to 99.9 wt %, 90 wt % to 99.9 wt %, or 90 wt % to 99 wt % based on 100 wt % of the total primer layer.

In an embodiment, the negative electrode coating layer refers to a layer that helps lithium ions deintercalated from the positive electrode active material during charging and discharging of an all-solid-state battery to move toward the negative electrode and be precipitated on the surface of a current collector. That is, a lithium deposition layer is formed between the current collector and the negative electrode coating layer due to the precipitation of lithium ions, and the lithium deposition layer acts as a negative electrode active material, and such a negative electrode is generally called a deposition-type negative electrode. The metal and amorphous carbon included in the negative electrode coating layer do not act as a negative electrode active material that directly participate in the charge and discharge reaction. . . . This deposition-type negative electrode means a negative electrode that does not include a negative electrode active material if assembling a battery, but in which the lithium deposition layer acts as a negative electrode active material.

The thickness of the negative electrode coating layer may be 1 μm to 15 μm, or may be 5 μm to 10 μm. Of course, as explained above, if the thickness of the negative electrode coating layer is within the above range, and the thicknesses of the primer layer and the negative electrode coating layer are within the above ranges, there may be an advantage in that short circuit may be prevented well while lithium is precipitated during charging, and at the same time, the flux of lithium ions may be induced more uniformly.

In an embodiment, the negative electrode coating layer includes a carbon material and a metal.

The metal included in the negative electrode coating layer may be Ag, Au, Sn, Zn, Al, Mg, Ge, Cu, In, Ni, Bi, Pt, Pd, or a combination thereof. In an embodiment, the metal may be Ag. The metal forms a solid solution with lithium ions, and because the negative electrode coating layer includes this metal, the electrical conductivity of the negative electrode may be further improved, the overvoltage characteristics may be improved, and the efficiency may be improved.

The metal may be a nanoparticle, and a size of the metal nanoparticle may be, for example, an average size of 5 nm to 80 nm, but a nanometer size may be suitable. By using the metal nanoparticles having such nano-size, the battery characteristics (e.g., cycle-life characteristics) of the all-solid-state battery may be further improved. If the metal particle size increases to the micrometer level, the uniformity of the metal particles in the negative electrode coating layer decreases, which is not suitable because the current density in a specific area increases and the cycle-life characteristics may deteriorate.

In the negative electrode coating layer according to an embodiment, an amount of the metal may be 3 wt % to 50 wt %, 3 wt % to 30 wt %, 4 wt % to 25 wt %, 4.5 wt % to 20 wt %, or 4.5 wt % to 15 wt % based on 100 wt % of the negative electrode coating layer.

The carbon material included in the negative electrode coating layer may be amorphous carbon, crystalline carbon, or a combination thereof.

The amorphous carbon may be carbon black, acetylene black, denka black, ketjen black, furnace black, activated carbon, or a combination thereof. An example of the carbon black is Super P (Timcal). The crystalline carbon may be natural graphite, artificial graphite, mesophase carbon microbeads, or a combination thereof.

During the all-solid-state battery fabricating process, the carbon material may act as a cushion in the pressing process, and lithium may be adsorbed on the surface of the carbon materials during charging and discharging, allowing metal to function appropriately.

Additionally, the carbon material may be a single particle or an aggregate having a secondary particle in which primary particles are aggregated. If the carbon material is a single particle, it may be an amorphous carbon particle having an average particle diameter of less than or equal to 100 nm, for example, a nanosize of 10 nm to 100 nm.

If the carbon material is an aggregate, the particle size of the primary particle may be 20 nm to 100 nm, and the particle size of the secondary particle may be 1 μm to 20 μm.

In an embodiment, the particle size of the primary particles may be greater than or equal to 20 nm, greater than or equal to 30 nm, greater than or equal to 40 nm, greater than or equal to 50 nm, greater than or equal to 60 nm, greater than or equal to 70 nm, greater than or equal to 80 nm, or greater than or equal to 90 nm, and less than or equal to 100 nm, less than or equal to 90 nm, less than or equal to 80 nm, less than or equal to 70 nm, less than or equal to 60 nm, less than or equal to 50 nm, less than or equal to 40 nm, or less than or equal to 30 nm.

In an embodiment, the particle size of the secondary particles may be greater than or equal to 1 μm, greater than or equal to 3 μm, greater than or equal to 5 μm, greater than or equal to 7 μm, greater than or equal to 10 μm, or greater than or equal to 15 μm, and less than or equal to 20 μm, less than or equal to 15 μm, less than or equal to 10 μm, less than or equal to 7 μm, less than or equal to 5 μm, or less than or equal to 3 μm.

The shape of the primary particles may be spherical, elliptical, plate-shaped, and a combination thereof, and in an embodiment, the shape of the primary particles may be spherical, elliptical, and a combination thereof.

Additionally, the carbon material may be present in an amount of 60 wt % to 95 wt %, 70 wt % to 95 wt %, 75 wt % to 95 wt %, 80 wt % to 95 wt %, or 85 wt % to 95 wt % based on 100 wt % of the total weight of the negative electrode coating layer.

In an embodiment, the negative electrode coating layer may include a binder, examples of which include a styrene butadiene rubber (SBR), polytetrafluoroethylene, polyvinylidene fluoride, polyethylene, a vinylidene fluoride/hexafluoropropylene copolymer (i.e., polyvinylidene fluoride-hexafluoropropylene), polyacrylonitrile, polymethylmethacrylate, carboxymethylcellulose, hydroxypropylcellulose, diacetylcellulose, or a combination thereof. The carboxymethyl cellulose may be an alkali metal salt thereof, and the alkali metal may be Na or Li. The binder is not limited to these and any binder used in the relevant technical field may be used.

According to an embodiment, in the negative electrode coating layer, an amount of the binder may be 1 wt % to 20 wt %, 3 wt % to 15 wt %, or 5 wt % to 10 wt % based on 100 wt % of the total negative electrode coating layer. If the binder amount is within the above range, the binder may act as a network between the metal, amorphous carbon, thereby stably maintaining the shape of the negative electrode.

The negative electrode coating layer may further include an additive such as a filler, or a dispersant. As the filler and dispersant that may be included in the negative electrode coating layer, known materials generally used in all-solid-state batteries may be used.

According to an embodiment, the negative electrode may further include a lithium-containing layer formed during initial charging after battery fabricating between the current collector and the primer layer.

The lithium-containing layer may act as a lithium reservoir. A thickness of the lithium-containing layer may be 1 μm to 1000 μm, 1 μm to 500 μm, 1 μm to 200 μm, 1 μm to 150 μm, 1 μm to 100 μm, or 1 μm to 50 μm. If the thickness of the lithium-containing layer is within the above range, it may properly function as a lithium storage layer and may further improve its cycle-life.

The lithium-containing layer may be formed if lithium ions are deintercalated from the positive electrode active material during charging after the battery is fabricated, pass through the solid electrolyte, and move toward the negative electrode, resulting in lithium being precipitated and electrodeposited on the negative electrode current collector.

The charging process may be a formation process performed 1 time to 3 times at 0.05 C to 1 C at about 25° C. to 50° C. If lithium is precipitated and electrodeposited to form a lithium-containing layer, the lithium included in the lithium-containing layer is ionized and moves toward the positive electrode during discharge, so that this lithium may be used as a positive electrode active material.

In an embodiment, because the lithium-containing layer is located between the current collector and the primer layer, not only the negative electrode coating layer but also the primer layer may serve as a protective layer of the lithium-containing layer, thereby suppressing the precipitation and growth of lithium dendrites. As a result, short circuiting and capacity reduction of the all-solid-state battery may be suppressed, and as a result, the cycle-life of the all-solid-state battery may be improved.

In an embodiment, the current collector may include, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil or sheet. A thickness of the current collector may be 1 μm to 20 μm, 5 μm to 15 μm, or 7 μm to 10 μm.

The current collector may include a metal substrate and may further include a thin film formed on the substrate. The thin film may include an element that may form an alloy with lithium, and may be, for example, gold, silver, zinc, tin, indium, silicon, aluminum, bismuth, or a combination thereof, but is not limited thereto, and in the technical field, any element that may form an alloy with lithium may be used. If the current collector further includes the thin film and the lithium deposition layer is formed by precipitating during charging, a more flattened lithium deposition layer may be formed, thereby further improving the cycle-life of the all-solid-state battery.

A thickness of the thin film may be 1 nm to 800 nm, 10 nm to 700 nm, 50 nm to 600 nm, or 100 nm to 500 nm. If the film thickness is within the above range, the cycle-life characteristics may be further improved.

Another embodiment provides an all-solid-state battery including the negative electrode, a positive electrode and a solid electrolyte layer between the negative electrode and the positive electrode.

The solid electrolyte layer may include a solid electrolyte. The solid electrolyte may be an inorganic solid electrolyte such as a sulfide-based solid electrolyte, an oxide-based solid electrolyte, a halide-based solid electrolyte, or a solid polymer electrolyte. In an embodiment, the solid electrolyte may be a sulfide-based solid electrolyte, for example, an argyrodite-type sulfide-based solid electrolyte. The sulfide-based solid electrolyte is suitable because it has superior ionic conductivity compared to other solid electrolytes such as oxide-based solid electrolytes, and may exhibit excellent cycle-life characteristics over a wider operating range.

The sulfide-based solid electrolyte may be Li₂S—P₂S₅, Li₂S—P₂S₅—LiX (wherein X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are integers of 0 or more and 12 or less and Z is one of Ge, Zn, or Ga), Li₂S—GeS₂, Li₂S—SiS₂—Li₃PO₄, Li₂S—SiS₂—LiₚMO_{q} (wherein p and q are each 0 or more and 12 or less and M is one of P, Si, Ge, B, Al, Ga, or In), or LiₐM_{b}P_{c}S_{d}Aₑ (wherein a, b, c, d, and e are each 0 or more and 12 or less, but a, b, c, d, and e are not all 0, and M is Ge, Sn, Si, or a combination thereof, and A is one of F, Cl, Br, or I). For example, it may be, for example, Li₇₋ₓPS₆₋ₓIₓ (0≤x≤2), Li₇₋ₓPS₆₋ₓClₓ (0≤x≤2), Li₇₋ₓPS₆₋ₓBrₓ (0≤x≤2), or Li₇₋ₓPS₆₋ₓIₓ (0≤x≤2). In addition, specifically, it may be Li₃PS₄, Li₃PS₄, Li₇P₃S₁₁, Li₇PS₆, Li₆PS₅Cl, Li₆PS₅Cl, Li₆PS₅Br, Li₆PS₅I, Li_{5.8}PS_{4.8}Cl_{1.2}, or Li_{6.2}PS_{5.2}Br_{0.8}.

The sulfide-based solid electrolyte may be obtained by, for example, mixing Li₂S and P₂S₅ in a mole ratio of 50:50 to 90:10 or 50:50 to 80:20. Within the above mixing ratio range, a sulfide-based solid electrolyte having excellent ionic conductivity may be prepared. The ionic conductivity may be further improved by adding SiS₂, GeS₂, B₂S₃, and the like as other components thereto. Mechanical milling or a solution method may be applied as a mixing method. The mechanical milling is to make starting materials into particulates by putting the starting materials, ball mills, and the like in a reactor and fervently stirring them. The solution method may be performed by mixing the starting materials in a solvent to obtain a solid electrolyte as a precipitate. Additionally, additional firing may be performed after mixing. If additional firing is performed, the crystals of the solid electrolyte may become more solid.

The sulfide-based solid electrolyte may be amorphous or crystalline, or may be a mixture of the two. Of course, a commercially available solid electrolyte may be used as the sulfide-based solid electrolyte.

The oxide-based inorganic solid electrolyte may be, for example, Li₁₊ₓTi₂₋ₓAl(PO₄)₃ (LTAP) (0≤x≤4), Li_{1+x+y}AlₓTi₂₋ₓSiyP_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), Pb(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, and 0≤y≤1), lithium lanthanum titanate (LiₓLa_{y}TiO₃, 0<x<2, and 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (M=Te, Nb, or Zr, and x is an integer of 1 to 10), or a mixture thereof.

The halide-based solid electrolyte may include a Li element, an M element (M is a metal other than Li), and an X element (X is a halogen). Examples of X may include F, Cl, Br, and I. In particular, in the halide-based solid electrolyte, at least one of Br and Cl is suitable as the above X. In addition, examples of M may include metal elements such as Sc, Y, B, Al, Ga, and In.

A composition of the halide-based solid electrolyte is not particularly limited, but may be represented by Li₆₋₃ₐMₐBr_{b}Cl_{c} (where M is a metal other than Li, 0<a<2, 0≤b≤6, 0≤c≤6, b+c=6). At this time, a may be 0.75 or more, 1 or more, and a may be 1.5 or less. The b may be 1 or more, and may be 2 or more. Additionally, the c may be 3 or more, and may be 4 or more. Specific examples of the halide-based solid electrolyte may be Li₃YBr₆, Li₃YCl₆, or Li₃YBr₂Cl₄.

The solid polymer electrolyte may include, for example, one or more selected from polyethylene oxide, poly(diallyldimethylammonium) trifluoromethanesulfonylimide (poly(diallyldimethylammonium)TFSI), Cu₃N, Li₃N, LiPON, Li₃PO₄.Li₂S.SiS₂, Li₂S.GeS₂.Ga₂S₃, Li₂O.11Al₂O₃, Na₂O.11Al₂O₃, (Na,Li)₁₊ₓTi₂₋ₓAlₓ(PO₄)₃ (0.1≤x≤0.9), Li₁₊ₓHf₂₋ₓAlₓ(PO₄)₃ (0.1≤x≤0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, Na-silicates, Li_{0.3}La_{0.5}TiO₃, Na₅MSi₄O₁₂ (wherein M is a rare earth element of Nd, Gd, Dy, and the like), Li₅ZrP₃O₁₂, Li₅TiP₃O₁₂, Li₃Fe₂P₃O₁₂, Li₄NbP₃O₁₂, Li₁₊ₓ(M,Al,Ga)ₓ(Ge_{1-y}Ti_{y})₂₋ₓ(PO₄)₃ (x≤0.8, 0≤y≤1.0, M is Nd, Sm, Eu, Gd, Tb, Dy, Ho, Er, Tm, or Yb), Li_{1+x+y}QₓTi₂₋ₓSi_{y}P_{3-y}O₁₂ (0<x≤0.4, 0<y≤0.6, and Q is Al or Ga), Li₆BaLa₂Ta₂O₁₂, Li₇La₃Zr₂O₁₂, Li₅La₃Nb₂O₁₂, Li₅La₃M₂O₁₂ (M is Nb or Ta), and Li₇₊ₓAₓLa₃₋ₓZr₂O₁₂ (0<x<3, A is Zn).

The solid electrolyte may in the form of particles, and an average particle diameter (D50) may be less than or equal to 5.0 μm, for example, 0.1 μm to 5.0 μm, 0.5 μm to 5.0 μm, 0.5 μm to 4.0 μm, 0.5 μm to 3.0 μm, 0.5 μm to 2.0 μm, or 0.5 μm to 1.0 μm.

The solid electrolyte layer may further include a binder. At this time, the binder may be a styrene butadiene rubber, polytetrafluoroethylene, polyvinylidene fluoride, polyethylene, an acrylate-based polymer, or a combination thereof, but is not limited thereto, and anything used as a binder in the art may be used. The acrylate-based polymer may be butyl acrylate, polyacrylate, polymethacrylate, or a combination thereof.

The solid electrolyte layer may be formed by adding a solid electrolyte to a binder solution, coating it on a base film, and drying the resultant. The solvent of the binder solution may be isobutyryl isobutyrate, xylene, toluene, benzene, hexane, or a combination thereof. A forming process of the solid electrolyte layer is well known in the art, and thus a detailed description thereof will be omitted.

A thickness of the solid electrolyte layer may be, for example, 10 μm to 150 μm.

The solid electrolyte layer may further include an alkali metal salt, and/or an ionic liquid, and/or a conductive polymer.

The alkali metal salt may be, for example, a lithium salt. An amount of the lithium salt in the solid electrolyte layer may be greater than or equal to 1 M, for example, 1 M to 4 M. In this case, the lithium salt may improve ionic conductivity by improving lithium ion mobility of the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato) borate (LiBOB), lithium oxalyldifluoroborate (LIODFB), lithium difluoro(oxalato) borate (LIDFOB), lithium bis(trifluoromethanesulfonyl)imide (LiTFSI, LiN(SO₂CF₃)₂), lithium bis(fluorosulfonyl)imide, LiFSI, LiN(SO₂F)₂), LiCF₃SO₃, LiAsF₆, LiSbF₆, LiClO₄, or a mixture thereof.

In addition, the lithium salt may be an imide-based salt, for example, the imide-based lithium salt may be lithium bis(trifluoromethane sulfonyl) imide (LiTFSI, LiN(SO₂CF₃)₂), and lithium bis(fluorosulfonyl)imide (LiFSI, LiN(SO₂F)₂). The lithium salt may maintain or improve ionic conductivity by appropriately maintaining chemical reactivity with the ionic liquid.

The ionic liquid has a melting point below room temperature, so it is in a liquid state at room temperature and refers to a salt or room temperature molten salt composed of ions alone.

The ionic liquid may be a compound including a) at least one cation selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, triazolium-based, and a mixture thereof, and b) at least one anion selected from BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻.

The ionic liquid may be, for example, one or more selected from N-methyl-N-propylpyrrolidinium bis(trifluoromethanesulfonyl)imide N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

The positive electrode includes a positive electrode current collector and a positive electrode active material layer on one surface of the positive electrode current collector.

The positive electrode active material layer may include a positive electrode active material. The positive electrode active material may be a positive electrode active material capable of reversibly intercalating and deintercalating lithium ions and for example, the positive electrode active material may be, for example, at least one of a composite oxide of lithium and a metal selected from cobalt, manganese, nickel, and a combination thereof. Examples of the positive electrode active material may include LiₐA_{1-b}B¹_{b}D¹₂ (0.90≤a≤1.8, 0≤b≤0.5); LiₐE_{1-b}B¹_{b}O_{2-c}D¹_{c} (0.90≤a≤1.8, 0≤b≤0.5, 0≤c≤0.5); LiₐE_{2-b}B¹_{b}O_{4-c}D¹_{c} (0.90≤a≤1.8, 0≤b≤0.5, 0≤c≤05); LiₐNi_{1-b-c}Co_{b}B¹_{c}D¹_{α} (0.90≤a≤1.8, 0≤b≤0.5, 0≤c≤0.5, 0<α≤2); LiₐNi_{1-b-c}Co_{b}B¹_{c}O_{2-α}F¹_{α} (0.90≤a≤1.8, 0≤b≤0.5, 0≤c≤0.5, 0<α<2); LiₐNi_{1-b-c}Co_{b}B¹_{c}O_{2-α}F¹₂ (0.90≤a≤1.8, 0≤b=0.5, 0≤c≤0.5, 0<α<2); LiₐNi_{1-b-c}Mn_{b}B¹_{c}D¹_{α} (0.90≤a≤1.8, 0≤b≤0.5, 0≤c≤0.5, 0<α≤2); LiₐNi_{1-b-c}Mn_{b}B¹_{c}O_{2-α}F¹_{α} (0.90≤a≤1.8, 0≤b≤0.5, 0≤c≤0.5, 0<α<2); LiₐNi_{1-b-c}Mn_{b}B¹_{c}O_{2-α}F¹₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMnG_{b}O₂ (0.90≤a≤1.8, 0.001≤b≤0.1); LiₐMn₂G_{b}O₄ (0.90≤a≤1.8, 0.001≤b≤0.1); QO₂; QS₂; LiQS₂; V₂O₅; LiV₂O₅; LiI¹O₂; LiNiVO₄; Li_{(3-f)}J₂(PO₄)₃(0≤f≤2); Li_{(3-f)}Fe₂(PO₄)₃(0≤f≤2); or LiFePO₄.

In the above chemical formulas, A is Ni, Co, Mn, or a combination thereof; B¹ is Al, Ni, Co, Mn, Cr, Fe, Mg, Sr, V, a rare earth element, or a combination thereof; D¹ is O, F, S, P, or a combination thereof; E is Co, Mn, or a combination thereof; F¹ is F, S, P, or a combination thereof; G is Al, Cr, Mn, Fe, Mg, La, Ce, Sr, V, or a combination thereof; Q is Ti, Mo, Mn, or a combination thereof; I¹ is Cr, V, Fe, Sc, Y, or a combination thereof; J is V, Cr, Mn, Co, Ni, Cu, or a combination thereof; and L¹ is Mn, Al, or a combination thereof.

According to an embodiment, the positive electrode active material may be a ternary lithium transition metal such as LiNiₓCo_{y}Al_{z}O₂ (NCA), LiNiₓCo_{y}Mn_{z}O₂ (NCM) (wherein 0<x<1, 0<y<1, 0<z<1, x+y+z=1).

Also, the compounds may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound, and for example, the method may include any coating method such as spray coating, dipping, and the like, but is not illustrated in more detail since it is well-known in the related field.

In addition, as the coating layer, any known coating layer for the positive electrode active material of an all-solid-state battery may be applied, examples of which include Li₂O—ZrO₂ (LZO).

In addition, if the positive electrode active material includes nickel, cobalt and manganese, or nickel, cobalt and aluminum, the capacity density of the all-solid-state battery may be further improved and metal elution from the positive electrode active material in the charged state may be further reduced. Because of this, the long-term reliability and cycle characteristics of the all-solid-state battery may be further improved in a charged state.

Here, examples of the shape of the positive electrode active material include particle shapes such as spheres and ellipsoids-spheres. Additionally, the average particle diameter of the positive electrode active material is not particularly limited, and may be within a range applicable to the positive electrode active material of existing all-solid-state rechargeable batteries. Additionally, the content of the positive electrode active material in the positive electrode active material layer is not particularly limited, and may be within a range applicable to the positive electrode layer of an existing all-solid-state rechargeable batteries.

The positive electrode active material layer may further include a solid electrolyte. The solid electrolyte included in the positive electrode active material layer may be the aforementioned solid electrolyte, and in this case, it may be the same as or different from the solid electrolyte included in the solid electrolyte layer. The solid electrolyte may be included in an amount of 10 wt % to 30 wt % based on a total weight of the positive electrode active material layer.

The current collector may include, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil or sheet.

The positive electrode active material layer may further include a binder and/or a conductive material.

The binder may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyvinylidene fluoride-hexapolypropylene, polyethylene, polypropylene, styrene-butadiene rubber, an acrylated styrene-butadiene rubber, an epoxy resin, nylon, and the like, but is not limited thereto.

The binder may be included in an amount of 0.1 wt % to 5 wt %, or 0.1 wt % to 3 wt %, based on a total weight of each component of the positive electrode for the all-solid-state battery, or based on a total weight of the positive electrode active material layer. Within the above amount range, the binder may sufficiently exhibit adhesive ability without deteriorating battery performance.

The conductive material is used to impart conductivity to the electrode, and any material that does not cause chemical change and conducts electrons may be used in the battery, and examples thereof may include a carbon-based material such as natural graphite, artificial graphite, carbon black, acetylene black, ketjen black, a carbon fiber, a carbon nanotube, and the like, a metal-based material including copper, nickel, aluminum, silver, etc. and in the form of a metal powder or a metal fiber, a conductive polymer such as a polyphenylene derivative, or a mixture thereof.

The conductive material may be included in an amount of 0.1 wt % to 5 wt %, or 0.1 wt % to 3 wt %, based on a total weight of each component of the positive electrode for the all-solid-state battery, or based on a total weight of the positive electrode active material layer. Within the above amount range, the conductive material may improve electrical conductivity without deteriorating battery performance.

A thickness of the positive electrode active material layer may be 90 μm to 200 μm. For example, the thickness of the positive electrode active material layer may be greater than or equal to 90 μm, greater than or equal to 100 μm, greater than or equal to 110 μm, greater than or equal to 120 μm, greater than or equal to 130 μm, greater than or equal to 140 μm, greater than or equal to 150 μm, greater than or equal to 160 μm, greater than or equal to 170 μm, greater than or equal to 180 μm, or greater than or equal to 190 μm, and less than or equal to 200 μm, less than or equal to 190 μm, less than or equal to 180 μm, less than or equal to 170 μm, less than or equal to 160 μm, less than or equal to 150 μm, less than or equal to 140 μm, less than or equal to 130 μm, less than or equal to 120 μm, or less than or equal to 110 μm. As described above, because the thickness of the positive electrode active material layer is thicker than that of the negative electrode active material layer, the capacity of the positive electrode is greater than that of the negative electrode.

The positive electrode may be manufactured by forming a positive electrode active material layer on a positive electrode current collector by dry or wet coating.

In an embodiment, a cushioning material may be additionally included to buffer thickness changes that occur if the all-solid-state battery is charged and discharged. The cushioning material may be present between the negative electrode and the case, and in the case of a battery in which one or more electrode assemblies are stacked, it may be present between different electrode assemblies.

The cushioning material may include a material that has an elastic recovery rate of 50% or more and has an insulating function, and specifically includes silicone rubber, acrylic rubber, fluorine-based rubber, nylon, synthetic rubber, or a combination thereof. The cushioning material may be present in the form of a polymer sheet.

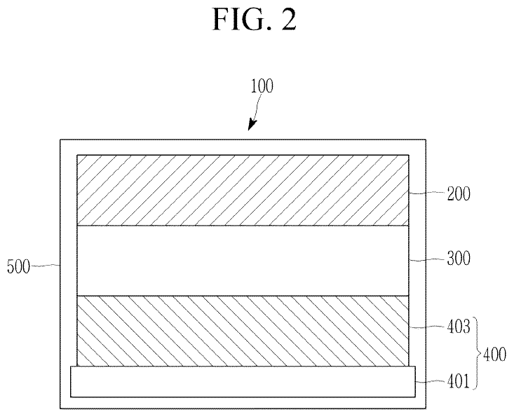

FIG. 2 schematically illustrates an all-solid-state battery according to one embodiment, and the all-solid-state rechargeable battery 100 includes a positive electrode 200 including a positive electrode current collector 201 and a positive electrode layer 203, a negative electrode 400 including a negative electrode current collector 401, a negative electrode coating layer 403, and a solid electrolyte layer 300 disposed between the positive electrode layer 203 and the negative electrode coating layer 403.

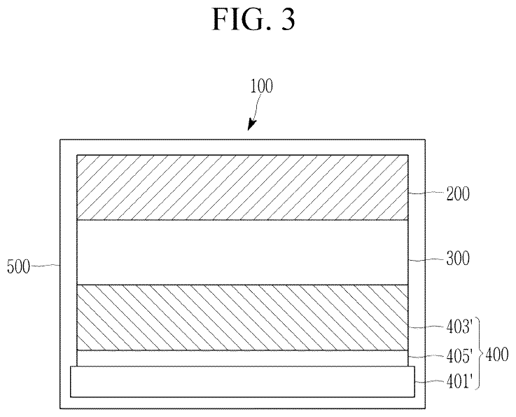

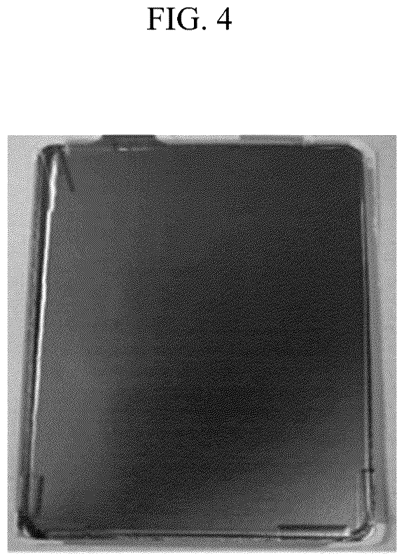

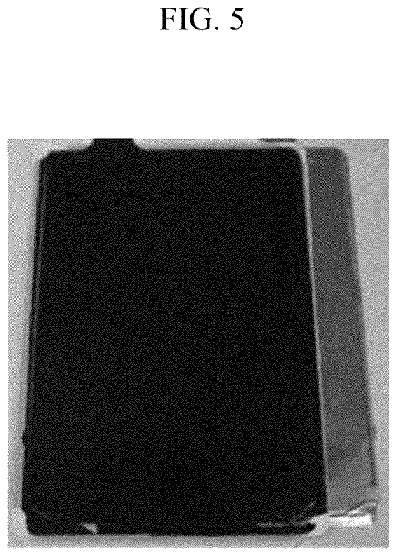

FIG. 3 schematically illustrates the structure of an all-solid-state battery in a charging state. An all-solid-state battery 100 includes a positive electrode 200 including a positive electrode current collector 201 and a positive electrode layer 203, a negative electrode 400 including a negative electrode current collector 401, a negative electrode coating layer 403, and a solid electrolyte 300 between the positive electrode 200 and the negative electrode 400, and includes a battery case 500 in which these are accommodated. Additionally, a lithium deposition layer 405′ is included between the current collector 401′ and the negative electrode coating layer 403″.

An all-solid-state battery according to an embodiment may be fabricated by placing a negative electrode, a positive electrode, and a solid electrolyte layer between the negative electrode and the positive electrode, preparing a stack, and pressing the stack.

The pressing process may be performed in the range of 25° C. to 90° C. Additionally, the pressing process may be performed by pressing at a pressure of less than or equal to 550 MPa, for example less than or equal to 500 MPa, for example 1 MPa to 500 MPa. The pressing time may vary depending on temperature and pressure, and may be, for example, less than 30 minutes. The pressing process may be, for example, an isostatic press, a warm isostatic press, a roll press, or a plate press.

### MODE FOR PERFORMING THE INVENTION

Hereinafter, examples of the present invention and comparative examples are described. These examples, however, are not in any sense to be interpreted as limiting the scope of the invention.

### Example 1

### (1) Manufacturing of Negative Electrode

95 wt % of single-walled carbon nanotubes with an average length of 5 μm (an aspect ratio: 2500) and 5 wt % of a carboxymethyl cellulose binder were mixed in a water solvent to prepare a primer layer composition.

92 wt % of carbon black with an average particle diameter (D50) of 30 nm, 3 wt % of Ag with an average size of 60 nm, 2 wt % of carboxymethyl cellulose, and 3 wt % of a styrene-butadiene rubber were mixed in water to prepare a negative electrode coating layer slurry.

The primer layer composition was coated on a 10 μm-thick stainless steel current collector and then, vacuum-dried at 80° C., and the negative electrode coating layer slurry was subsequently coated thereon and then, vacuum-dried at 80° C., manufacturing a negative electrode. In the manufactured negative electrode, a primer layer had a thickness of 1 μm, and a negative electrode coating layer had a thickness of 2 μm.

### (2) Manufacturing of Solid Electrolyte Layer

To an argyrodite-type solid electrolyte of Li₆PS₅Cl, an isobutyryl isobutyrate binder solution (a solid content: 50 wt %) prepared by adding an acrylate-based polymer of butyl acrylate, was added and then, mixed. Here, the solid electrolyte and the binder were mixed in a weight ratio of 98.7:1.3.

The mixing process was performed by using a Thinky mixer. Subsequently, 2 mm zirconia balls were added to the obtained mixture and then, stirred again by using a Thinky mixer to prepare slurry. The slurry was cast on a polytetrafluoroethylene release film and then, dried at room temperature to manufacture a 100 μm-thick solid electrolyte layer.

### (3) Manufacturing of All-Solid-State Battery Cell

85 wt % of a LiNi_{0.94}Co_{0.3}Al_{0.3}O₂ positive electrode active material, 13.5 wt % of an argyrodite-type solid electrolyte Li₆PS₅Cl, 1 wt % of a polyvinylidene fluoride-hexafluoropropylene (PVdF-HFP) binder, and 0.5 wt % of a carbon nanotube conductive material were mixed in an N-methyl pyrrolidone solvent with a Thinky mixer, preparing a positive electrode active material slurry. This positive electrode active material slurry was coated on an aluminum current collector and then, dried at 80° C. and vacuum-dried at 80° C., manufacturing a positive electrode having a positive electrode active material layer on the aluminum current collector. Herein, the positive electrode active material layer had a thickness of 120 μm.

The manufactured negative electrode, solid electrolyte, and positive electrode were sequentially stacked and then, subjected to a warm isostatic press (WIP) process with 500 Mpa, fabricating an all-solid-state battery cell.

### Example 2

A negative electrode and a half-cell were fabricated in the same manner as in Example 1 except that the primer layer was formed to be 1 μm thick, and the negative electrode coating layer was formed to be 7 μm thick.

### Example 3

A negative electrode and a half-cell were fabricated in the same manner as in Example 1 except that the primer layer was formed to be 1 μm thick, and the negative electrode coating layer was formed to be 10 μm thick.

### Comparative Example 1

### (1) Manufacturing of Negative Electrode

92 wt % of carbon black with an average particle diameter (D50) of 30 nm, 3 wt % of Ag with an average size of 60 nm, 2 wt % of carboxymethyl cellulose, and 3 wt % of a styrene-butadiene rubber were mixed in water to prepare a negative electrode coating layer slurry.

The negative electrode coating layer slurry was coated on a 10 μm-thick stainless steel foil current collector and then, vacuum-dried at 80° C., manufacturing a negative electrode. In the negative electrode, a negative electrode coating layer was formed to be 7 μm thick.

Except for using the negative electrode, a half-cell was fabricated in the same manner as in Example 1.

### Experimental Example 1) Evaluation of Peeling Phenomenon

After performing the warm isostatic press process in the all-solid-state battery fabricating process according to Example 1 and Comparative Example 1, the cells were evaluated with respect to peeling phenomenon between negative electrode coating layer and current collector. Among the results, the result of Example 1 is shown in FIG. 4, and the result of Comparative Example 1 is shown in FIG. 5.

As shown in FIG. 4, in the all-solid-state battery cell of Example 1, the negative electrode coating layer and the current collector were not peeled off but still maintained their stacked state. On the contrary, as shown in FIG. 5, in the all-solid-state battery cell of Comparative Example 1, the current collector in contact with the negative electrode coating layer was peeled off, exposing the surface of the negative electrode coating layer (black). In FIG. 4, a gray color at the bottom indicated a current collector, which was peeled from the negative electrode coating layer included in a second unit cell.

### Experimental Example 2) Electrical Resistance Evaluation

The negative electrodes according to Examples 1 to 3 and Comparative Examples 1 to 4 were probed with 46 pins in a 4-probe method (XF057, HIOKI E.E. Corp.) to evaluate electrical resistance, and the results are shown in Table 1.

### Experimental Example 3) Evaluation of Charge/Discharge Efficiency

The all-solid-state half-cells according to Examples 1 to 3 and Comparative Examples 1 to 4 were once charged and discharged at 0.05 C. A ratio of discharge capacity to charge capacity (1^{st} discharge capacity/1^{st} charge capacity) was shown as efficiency in Table 1.

TABLE 1

| | Resistance (Ω) | Efficiency (%) |
|---|---|---|
| Example 1 | 2.7 | 90.62 |
| Example 2 | 1.9 | 92.43 |
| Example 3 | 2.5 | 91.42 |
| Comparative Example 1 | 3.1 | 89.7 |

As shown in Table 1, the all-solid-state battery cells of Examples 1 to 3, compared with that of Comparative Example 1, exhibited low resistance and excellent efficiency.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A negative electrode for an all-solid-state battery, comprising a current collector;
a primer layer located on the current collector, comprising a linear carbon-based material, and having a thickness of less than or equal to 1 μm; and
a negative electrode coating layer comprising a carbon material and a metal on the primer layer.

2. The negative electrode for an all-solid-state battery as claimed in claim 1, wherein the linear carbon-based material comprises a carbon nanotube, a carbon nanofiber, or a combination thereof.

3. The negative electrode for an all-solid-state battery as claimed in claim 2, wherein the carbon nanotube comprises a single-walled carbon nanotube, a double-walled carbon nanotube, a multi-walled carbon nanotube, or a combination thereof.

4. The negative electrode for an all-solid-state battery as claimed in claim 1, wherein a thickness of the primer layer is 0.01 μm to 1 μm.

5. The negative electrode for an all-solid-state battery as claimed in claim 1, wherein a thickness ratio of the primer layer and the negative electrode coating layer is 1:2 to 1:10.

6. The negative electrode for an all-solid-state battery as claimed in claim 1, wherein an aspect ratio of the linear carbon-based material is 500 to 10000.

7. The negative electrode for an all-solid-state battery as claimed in claim 1, wherein the primer layer has a sheet resistance of 0.1 mΩ/sq to 10 mΩ/sq.

8. The negative electrode for an all-solid-state battery as claimed in claim 1, wherein an average length of the linear carbon-based material is 0.01 μm to 10 μm.

9. The negative electrode for an all-solid-state battery as claimed in claim 1, wherein the metal includes Ag, Au, Sn, Zn, Al, Mg, Ge, Cu, In, Ni, Bi, Pt, Pd, or a combination thereof.

10. The negative electrode for an all-solid-state battery as claimed in claim 1, wherein the carbon material comprises amorphous carbon comprising carbon black, acetylene black, denka black, ketjen black, furnace black, activated carbon, or a combination thereof.

11. An all-solid-state battery, comprising
the negative electrode of claim 1;
a positive electrode; and
a solid electrolyte layer between the negative electrode and the positive electrode.

12. The all-solid-state battery as claimed in claim 11, wherein the solid electrolyte is a sulfide-based solid electrolyte.

13. The all-solid-state battery as claimed in claim 11, wherein the all-solid-state battery further comprises a lithium-containing layer between the current collector and the negative electrode coating layer during initial charging.
